(19) United States
(12) Patent Application Publication
(10) Pub. No.: US 2026/0109816 A1
(43) Pub. Date: Apr. 23, 2026

(54) ORGANIC REINFORCEMENT OF A POLYAMIDE WITH THE IN SITU SYNTHESIS OF A POLYIMIDE PHASE BY REACTIVE EXTRUSION

(71) Applicants: UNIVERSITÉ CLAUDE BERNARD LYON 1 (UCBL), Villeurbanne (FR); CENTRE NATIONAL DE LA RECHERCHE SCIENTIFIQUE (CNRS), Paris (FR); UNIVERSITÉ JEAN MONNET SAINT-ETIENNE (UJM), Saint-Etienne (FR); INSTITUT NATIONAL DES SCIENCES APPLIQUÉES DE LYON (INSA LYON), Villeurbanne (FR)

(72) Inventors: Philippe CASSAGNAU, Villeurbanne (FR); Karim DELAGE, Villeurbanne (FR); Véronique BOUNOR-LEGARE, Paris (FR); Catherine MARESTIN, Paris (FR); Charlotte DUBOIS, Seneffe (BE); Nicolas GAROIS, Amilly (FR)

(21) Appl. No.: 19/166,335

(22) PCT Filed: Apr. 3, 2024
(86) PCT No.: PCT/EP2024/059017

§ 371 Date: Sep. 17, 2025

(30) Foreign Application Priority Data
Apr. 3, 2023 (EP) 23315077.0

(51) Int. Cl. C08G 73/14; C08G 73/10

(52) U.S. Cl. CPC C08G 73/14; C08G 73/1028

(57) ABSTRACT

The disclosure relates to a reinforced polyamide and to a process to produce a reinforced polyamide comprising providing components being one or more polyamides, one or more dianhydrides, and one or more diamines; wherein the one or more polyamides are provided at a content of at least 60 wt. % based on the total weight of the components and wherein the one or more polyamides comprise at least one polyamide having amide groups separated by at least 10 CH₂ groups; performing in situ synthesis of a polyimide by reactive extrusion of the components wherein the residence time is less than 10 minutes; and recovering a polyamide-polyimide blend being a reinforced polyamide comprising a continuous polyamide phase and a polyimide dispersed phase.

### TECHNOLOGICAL FIELD

The present disclosure relates to a process for producing a reinforced polyamide comprising a continuous phase being a polyamide and another phase being a dispersed polyimide phase which is synthesized in situ. The disclosure also relates to the reinforced polyamide obtained by such a process.

### TECHNOLOGICAL BACKGROUND

Polyamides (PA) are semi-crystalline polymers with very attractive properties such as excellent mechanical strength, high temperature and chemical resistance and ease of processing. They are widely used in a large field of industrial applications including automotive, textile, packaging, electric and electronics. Despite their advantages, polyamides have some limitations such as moisture absorption, notch sensitivity, relatively low impact strength and poor dimensional stability.

Since the 1960s, a lot of research has been done on the improvement of the physical properties of polyamides. For example, to improve their impact resistance, the toughening of polyamides by the addition of an elastomeric dispersed phase has been investigated. Polyamides have also been blended with thermoplastics such as polyolefins, acrylonitrile-butadiene-styrene (ABS), poly(dimethyl phenylene oxide) or polystyrene, to improve their mechanical, thermal and water barrier properties. In most of these examples, a maleic anhydride grafted polymer is used as a compatibilizer to create a good affinity between the two phases, with the lowest possible interfacial tension. The maleic anhydride groups of the compatibilizer can react with the amine end-groups of the polyamide chains, leading to the formation of graft or block-copolymers.

Furthermore, polyamides are very interesting for reactive blending as both amine and carboxylic end-groups or amide chain moieties can be considered as potential chemical reactive sites. Compatibilization by amide exchange in polyamide blends has been reported by many authors, mostly in polyamide-polyamide blends. An example of a polyamide/polystyrene (PS) reactive blend was reported in Koulic, C. and R. Jérôme, Nanostructured Polyamide by Reactive Blending. 1. Effect of the Reactive Diblock Composition. Macromolecules, 2004. 37(9): p. 3459-3469, where the polystyrene was end-capped with phthalic anhydride to enable reactions with the amine end-groups of polyamide. Similarly, in Freluche, M., et al., Graft copolymers of poly(methyl methacrylate) and polyamide-6: Synthesis by reactive blending and characterization. Macromolecules, 2006. 39(20): p. 6905-6912, a poly(methyl methacrylate) (PMMA) bearing glutaric anhydride groups exhibited a high reactivity towards the amine end-groups of PA-6. In these studies, no compatibilizer was used as the two phases were able to chemically react during reactive blending.

Telen et al. in “Random Copolymers from Polyamide 11 and Polyamide 12 by Reactive Extrusion: Synthesis, Eutectic Phase Behavior, and Polymorphism” (Macromolecules, 2016. 49) reported transamidation reactions in a polyamide-11/polyamide-12 blend. Their goal was to obtain a random structure and thus create a material with lower melting and crystallization temperatures. Several ratios of PA-11 and PA-12 were blended in a mini twin-screw extruder at 350° C. for 30 min. The formation of copolymers from transamidation reactions led to the creation of a new material with a single melting peak. For a PA-11/PA-12 40/60 wt. % blend, a melting temperature of 151° C. was obtained, which is lower than PA-11 and PA-12 's melting temperatures (185° C. and 177° C. respectively).

Wang et al. in “Transamidation determination and mechanism of long chain-based aliphatic polyamide alloys with excellent interface miscibility” (Polymer, 2015. 59: p. 16-25) prepared blends of PA-6,12 and PA-10,12 from a dissolution-precipitation method. PA-6,12 and PA-10,12 in a 50/50 wt. % ratio were dissolved in trifluoroacetic acid and stirred for 10 h, and then precipitated into deionized water. Differential Scanning Calorimetry, variable temperature-FTIR and NMR were used to evidence transamidation between the two polymers. The ratio of CH₂/CONH was modified in the blends, due to the incorporation of PA-6,12 segments into PA-10,12 and vice versa, leading to the creation of PA-6,12-co-PA-10,12 copolymers. The in situ formed copolyamide acts as a compatibilizer at the interface, reducing the interfacial tension and thus increasing the interfacial adhesion which improves the compatibility of PA-6,12/PA-10,12 blends. Indeed, the double melting peak of both polyamide phases converged into a single melting peak for the PA-6,12/PA-10,12 blend.

Few blends of polyamide and polyimide have been already published in the open literature with a focus on the association of its specific properties such as thermal, mechanical or dielectric. For example, in Lee, J., et al., “Crystallization and Melting Behavior of Nylon 66/Poly(etherimide) Blends” (Polymer Journal, 1998. 30: p. 531-537).

Those studies show a real interest in blending polyamides with polyimides, to improve the mechanical or thermal properties of polyamides. Most studies report macroscopic characterizations, whereas rather very limited data can be found concerning structural and chemical evidence of the formation of copolymers (or covalent linkages between the blended polymers) as compatibilizers.

JP H09 165448 discloses a process to obtain a polyamide-polyimide block copolymer wherein the glass transition temperature of a crystalline or amorphous polyamide segment is lower than that of a crystalline or amorphous polyimide segment. The copolymer is obtained by dissolving a polyamide (e.g. nylon 11) in a phenolic solvent, thermally dissolving a tetracarboxylic dianhydride (e.g. pyromellitic dianhydride or 3,3′,4,4′-benzophenonetetracarboxylic dianhydride) in the resultant solution, adding a diamine (e.g. 4,4′-diaminodiphenyl ether or 4,4′-diaminodiphenylmethane) in a molar ratio to the dianhydride of (1:2)-(2:1) to the soln., and thermally reacting the solution at about 80-150° C. to thereby form polyimide segments and simultaneously to conduct addition polycondensation.

U.S. Pat. No. 5,013,799 discloses blends comprising from about 40 to 70 wt. % of a polyetherimide and the remainder one or more polyamides. The blends generally have a tensile strength that is greater than the tensile strength of polyetherimide-polyamide blends which do not contain from about 40 to 70% polyetherimide, while still retaining a good combination of other physical properties such as heat distortion characteristics and impact strength.

CN 114 716 678 A provides a preparation method of an imide structure polymer, which comprises, by weight, 10-90 parts of a reactive dispersion medium amide bond based polymer, 0-50 parts of a polymeric monomer binary acid, 5-100 parts of diamine, and 5-100 parts of carboxylic acid capable of forming cyclic anhydride and/or a derivative formed by the carboxylic acid. The carboxylic acid is at least one of ternary acid and quaternary acid, and the derivative is at least one of anhydride and ester; the method comprises mixing raw materials, taking a molten amide bond based polymer as a dispersion medium, reacting and mixing polymeric monomers in the dispersion medium, and polymerizing to obtain the polymer containing the imide structure.

Due to the length of the CH₂ aliphatic units and the arrangement of the amide groups in the chain, polyamides have a variety of structures on which their properties depend. The number of carbons in the repeat unit impacts the thermal and mechanical properties, as well as moisture absorption of the polymer. The melting point of polyamides decreases with the length of the aliphatic chain. For instance, PA-12 melts at 180° C. whereas PA-6 melts at 220° C. The amide function is hydrophilic and imparts a determining character to polyamides and their moisture sensitivity. With a longer aliphatic chain, the concentration in amide function is lower and the polyamide is thus less sensitive to water uptake.

However, there is still a need to improve the situation and to produce reinforced polyamide and/or to prevent the effects of water on polyamide.

One or more of the above needs can be fulfilled by the formation in situ in a polyamide matrix of a polyimide phase.

According to a first aspect, the disclosure provides a process to produce a reinforced polyamide remarkable in that it comprises:
a) providing components being one or more polyamides, one or more dianhydrides, and one or more diamines; wherein the one or more polyamides are provided at a content of at least 60 wt. % based on the total weight of the components; and wherein the one or more polyamides comprise at least one polyamide having amide groups separated by at least 10 CH₂ groups;
b) performing in situ synthesis of a polyimide by reactive extrusion of the components in a twin-screw extruder comprising a main hopper wherein the screw profile comprises two or more reverse conveying elements forming two or more hot zones to form a polyamide-polyimide blend wherein the residence time is less than 10 minutes; and
c) recovering a polyamide-polyimide blend being a reinforced polyamide comprising a continuous polyamide phase and a dispersed polyimide phase.

Surprisingly, the in situ synthesis of a polyimide (PI) phase dispersed in a polyamide matrix comprising a long aliphatic chain length wherein the two amide groups are separated by at least 10 CH₂ (such as a polyamide-12 (PA-12) matrix) led to the reinforcement of the polyamide phase. A nanometric nodular dispersion of PI was obtained, with average diameters less than 150 nm as determined by SEM.

As shown by the examples, it is possible to design new polyamide/polyimide blends with the in situ synthesis of the polyimide dispersed phase. For example, PA-12 has a low melting temperature and very little moisture absorption. PA-12/PI reactive blends were processed in a twin-screw extruder, with the concentrations of PI varying from 10 to 30 wt. %. Reactions between the polyamide and the in situ synthesized polyimide were evidenced. The impact of these reactions and the polyimide presence on the morphological, structural and mechanical properties of PA-12 was deeply scrutinized.

Blends of PA-12 and polyimide were prepared by reactive extrusion with the in situ synthesis of the PI dispersed phase. ¹³C NMR experiments evidenced the formation of copolymers between the two phases, through reactions between the poly(amic acid) intermediate and amide groups on the polyamide chains.

The mechanical properties of the blends were modified with the incorporation of PI. The Young's modulus slightly increased with the PI content (up to 8% for the sample containing 30% of PI) for the dry sample while strongly decreasing the melt viscosity (From 4000 Pa·s to 80 Pa·s). On the other hand, the Young modulus was increased up to +18% for humidity-conditioned samples containing 20 to 30 wt. % of PI corresponding to the Young modulus of dry PA12 sample. Spectacularly, the strain at break was considerable increased for dry samples due to the very fine dispersion of PI nodules (80 nm in diameter) from 120% (neat PA12) sample) to 230% of the sample containing 30% of PI. The strain at break was also increased for wet samples.

One or more of the following can be used to further define the process according to the first aspect:

For example, step (b) comprises performing the reactive extrusion with a residence time of less than 10 minutes, such as ranging from 10 seconds to less than 10 minutes; preferably with a residence time ranging from 15 seconds to 8 minutes; or with a residence time ranging from 20 seconds to 5 minutes; more preferably with a residence time ranging from 10 to 240 seconds; even more preferably, from 20 to 180 seconds; most preferably, from 40 to 150 seconds; and even most preferably, from 60 to 120 seconds

According to the disclosure, in step (a) of the process, the one or more polyamides are provided at a content of at least 60 wt. % based on the total weight of the components; preferably at a content ranging from 60 to 97 wt. %; more preferably from 62 to 95 wt. %; even more preferably, from 65 to 92 wt. %; most preferably from 70 to 90 wt. %.

With preference, polyimide is present in the reinforced polyamide at a content of from 3 to 40 wt. % of based on the total weight of the reinforced polyamide; preferably from 5 to 35 wt. %; more preferably from 8 to 32 wt. % and even more preferably from 10 to 30 wt. %.

In an embodiment, the reinforced polyamide comprises a continuous polyamide phase and a dispersed polyimide phase in the form of dispersed nodules with an average diameter of less than 150 nm as determined by SEM according to the description; preferably, of less than 120 nm; more preferably of less than 100 nm.

For example, the average diameter of the polyimide nodules ranges from 20 to 150 nm as determined by SEM according to the description; more preferably ranging from 30 to 130 nm; and even more preferably ranging from 40 to 120 nm; most preferably ranging from 50 to 100 nm; even most preferably, from 60 to 90 nm.

In a preferred embodiment, the one or more polyamides comprise at least one aliphatic polyamide having amide groups separated by at least 10 CH₂ groups.

For example, the one or more polyamides comprise at least one polyamide having amide groups separated by 10 to 12 CH₂ groups. Such polyamides are aliphatic polyamides comprising a long aliphatic chain length. For example, the one or more polyamides are selected from polyamide 11, polyamide 12, polyamide 12.12, polyamide 10.10, polyamide 10.12, polyamide 11.12, and any mixture thereof.

With preference, the one or more polyamides are or comprise polyamide 12.

In an embodiment, the one or more polyamide are selected to have the glass transition temperature (Tg) of the PI phase higher than the Tg of the PA phase; wherein the glass transition temperature is determined by DSC according to the description.

According to the disclosure, the polyamide-polyimide blend recovered at step c) further comprises one or more copolymers as evidenced by ¹³C NMR spectra.

### The One or More Dianhydrides

In a preferred embodiment, the one or more dianhydrides provided at step (a) are selected from one or more aromatic dianhydrides, one or more aliphatic dianhydrides, and any mixture thereof; preferably, the one or more dianhydrides provided at step (a) are or comprise one or more aromatic dianhydrides.

For example, the one or more dianhydrides provided at step (a) are selected from pyromellitic dianhydride (PMDA) 3,3′,4,4′-benzophenone tetracarboxylic dianhydride (BTDA), 3,3′,4,4′-biphenyl tetracarboxylic dianhydride (BPDA), 1S,2R,4S,5R-cyclohexanetetracarboxylic dianhydride (H-PMDA), 1,2,3,4-cyclobutanetetracarboxylic dianhydride (CBDA), bicyclo-[2.2.2]oct-7-ene-2-exo,3-exo,5-exo,6-exo-2,3:5,6-dianhydride (BTA), and any mixture thereof.

With preference, the one or more aromatic dianhydrides are or comprise pyromellitic dianhydride (PMDA) 3,3′,4,4′-benzophenone tetracarboxylic dianhydride (BTDA), 3,3′,4,4′-biphenyl tetracarboxylic dianhydride (BPDA), and any mixture thereof.

With preference, the one or more aliphatic dianhydrides are or comprise 1S,2R,4S,5R-cyclohexanetetracarboxylic dianhydride (H-PMDA), 1,2,3,4-cyclobutanetetracarboxylic dianhydride (CBDA), bicyclo-[2.2.2]oct-7-ene-2-exo,3-exo,5-exo,6-exo-2,3:5,6-dianhydride (BTA), and any mixture thereof.

### The One or More Diamines

In an embodiment, one or more diamines provided in step (a) are branched aliphatic diamines; preferably one or more diamines are selected from trimethyl hexamethylenediamine (TMD), methyl pentamethylenediamine (MPMD), and methyl octamethylenediamine (MOMD). More preferably the one or more diamines are or comprise trimethyl hexamethylenediamine (TMD).

### The Two or More Reverse Conveying Elements

In a preferred embodiment, the two or more reverse conveying elements are selected from kneading left-handed element and/or left-handed elements; with preference, the two or more hot zones comprise a first hot zone comprises successive kneading blocks elements over a length of at least 4 D followed by a left-handed element with D being the screw diameter, and one or more additional hot zones placed downstream the first hot zone are filled mixing zones, each comprising kneading blocks elements over a length of at least 4 D followed by a kneading left-handed element or by a left-handed element with D being the screw diameter.

### The Polyimide of the Polyamide-Polyimide Blend

In an embodiment, the polyimide in the polyamide-polyimide blend recovered in step (c) is an aliphatic-aromatic polyimide.

In an embodiment, the polyimide in the polyamide-polyimide blend recovered in step (c) has a glass temperature transition (Tg) of at least 100° C. as determined by DSC; preferably of at least 110° C.; more preferably of at least 120° C.; even more preferably of at least 130° C. or at least 135° C., or at least 140° C.

For example, the polyimide in the polyamide-polyimide blend recovered in step (c) has a glass temperature transition (Tg) ranging from 100° C. to 250° C. as determined by DSC; preferably ranging from 110° C. to 240° C.; more preferably ranging from 120° C. to 230° C.; more preferably ranging from 130° C. to 220° C.; even more preferably, from 135° C. to 210° C.; most preferably ranging from 140° C. to 200° C.; and even most preferably from 150° C. to 200° C.

According to a second aspect, the disclosure provides a reinforced polyamide remarkable in that it comprises a polyamide matrix phase, a dispersed polyimide phase, and one or more copolymers, wherein the polyimide of the polyimide phase has a glass temperature transition (Tg) of at least 100° C. as determined by DSC according to the description and is present in a content of from 3 to 40 wt. % based on the total weight of the reinforced polyamide; With preference, the polyimide has a glass temperature transition (Tg) ranging from 135 to 250° C. as determined by DSC according to the description, and/or the polyimide is an aliphatic-aromatic polyimide.

In a preferred embodiment, the polyamide matrix phase comprises at least one polyamide having amide groups separated by at least 10 CH₂ groups. For example, the polyamide matrix phase comprises one or more polyamides are selected from polyamide 11, polyamide 12, polyamide 12.12, polyamide 10.10, polyamide 10.12, polyamide 11.12, and any mixture thereof.

One or more of the following can be used to further define the reinforced polyamide according to the second aspect.

In an embodiment, the polyimide phase has a glass temperature transition (Tg) of at least 135° C. as determined by DSC; preferably of at least 140° C.; more preferably of at least 145° C.; even more preferably of at least 150° C.

For example, the polyimide in the polyamide-polyimide blend recovered in step (c) has a glass temperature transition (Tg) ranging from 135° C. to 250° C. as determined by DSC; preferably ranging from 135° C. to 240° C.; more preferably ranging from 140° C. to 230° C.; more preferably ranging from 140° C. to 220° C.; even more preferably, from 145° C. to 210° C.; most preferably ranging from 145° C. to 200° C.; and even most preferably from 150° C. to 200° C.

In a preferred embodiment, the reinforced polyamide comprises one or more polyamide selected from polyamide 11, polyamide 12, polyamide 12.12, polyamide 10.10, polyamide 10.12, polyamide 11.12. With preference, the one or more polyamides are or comprise polyamide 12.

In an embodiment, the reinforced polyamide comprises a continuous polyamide phase and a polyimide dispersed phase based on the total weight of the reinforced polyamide in the form of dispersed nodules with an average diameter of less than 150 nm as determined by SEM according to the description; with preference, of less than 120 nm; more preferably of less than 100 nm.

For example, the average diameter of the polyimide nodules ranges from 20 to 150 nm as determined by SEM according to the description; more preferably ranging from 30 to 130 nm; and even more preferably ranging from 40 to 120 nm; most preferably ranging from 50 to 100 nm; even most preferably, from 60 to 90 nm.

For example, the reinforced polyamide shows peaks at 29.6, 40.7 and 169.6 ppm on a ¹³C NMR spectra.

For example, the reinforced polyamide has been produced by the process according to the first aspect.

### DESCRIPTION OF THE FIGURES

FIG. 1 represents the chemical structure of the synthesized polyimide

FIG. 2 is an example of a twin screw profile with two reverse conveying elements

FIG. 3: SEM images of PA-12/PI 70/30 prepared (a): by simple melt blending in the micro extruder, (b): by in situ synthesis of the PI by reactive extrusion

FIG. 4: SEM images of PA-12/PI blends prepared by in situ synthesis by reactive extrusion

FIG. 5 Complex viscosity (Pa·s) of PA-12 and PA-12/PI in situ or melt blends

FIG. 6 Structures of (a): PA-12, (b): polyimide sequences possibly formed

FIG. 7 ¹³C NMR spectra between 20 and 53 ppm of PA-12, PI synthesized in solution and PA-12/PI 80/20 prepared in situ by reactive extrusion

FIG. 8 ¹³C NMR spectra between 166 and 186 ppm of PA-12, PI synthesized in solution and PA-12/PI 80/20 in situ prepared by reactive extrusion

FIG. 9 Mechanism of the formation of the di-amide copolymer during reactive extrusion

FIG. 10 Structure created after the reaction of the poly(amic acid) intermediate on the amide group of PA-12

FIG. 11 ¹³C NMR spectra between 20 and 53 ppm of PA-12/PI 70/30 prepared by simple melt blending or by reactive extrusion with the in situ synthesis of the polyimide phase

FIG. 12 ¹³C NMR spectra between 166 and 186 ppm of PA-12/PI 70/30 prepared by simple melt blending or by reactive extrusion with the in situ synthesis of the polyimide phase

FIG. 13 Tensile curves of the in situ PA-12/PI blends

FIG. 14 WAXS patterns of PA-12 and PA-12/PI in situ blends

FIG. 15 Lorentz corrected SAXS patterns for PA-12/PI blends prepared by reactive extrusion

FIG. 16 FTIR spectrum of the polyimide synthesized in solution

FIG. 17 ¹H NMR spectrum of the polyimide synthesized in solution

FIG. 18 ¹³C NMR spectra between 20 and 53 ppm of PA-12/PI blends containing 10, 20 and 30 wt. % of polyimide synthesized in situ by reactive extrusion

FIG. 19 ¹³C NMR spectra between 175 and 185 ppm of PA-12/PI blends containing 10, 20 and 30 wt. % of polyimide synthesized in situ by reactive extrusion

FIG. 20 SAXS patterns I(q)=f(q) for PA-12/PI blends prepared by reactive extrusion

### DETAILED DESCRIPTION

For the disclosure, the following definitions are given:

The terms “comprising”, “comprises” and “comprised of” as used herein are synonymous with “including”, “includes” or “containing”, “contains”, and are inclusive or open-ended and do not exclude additional, non-recited members, elements or method steps. The terms “comprising”, “comprises” and “comprised of” also include the term “consisting of”.

The recitation of numerical ranges by endpoints includes all integer numbers and, where appropriate, fractions subsumed within that range (e.g. 1 to 5 can include 1, 2, 3, 4, 5 when referring to, for example, a number of elements, and can also include 1.5, 2, 2.75 and 3.80, when referring to, for example, measurements). The recitation of endpoints also includes the recited endpoint values themselves (e.g. from 1.0 to 5.0 includes both 1.0 and 5.0). Any numerical range recited herein is intended to include all sub-ranges subsumed therein.

The term “polyamide” refers to a polymer with repeating units linked by amide bonds.

The term “NMR” stands for nuclear magnetic resonance.

The disclosure provides a process to produce a reinforced polyamide remarkable in that it comprises:
a) providing components being one or more polyamides, one or more dianhydrides, and one or more diamines; wherein the one or more polyamides are provided at a content of at least 60 wt. % based on the total weight of the components and wherein the one or more polyamides comprise at least one polyamide having amide groups separated by at least 10 CH₂ groups;
b) performing in situ synthesis of a polyimide by reactive extrusion of the components in a twin-screw extruder comprising a main hopper wherein the screw profile comprises two or more reverse conveying elements forming two or more hot zones to form a polyamide-polyimide blend wherein the residence time is less than 10 minutes; and
c) recovering a polyamide-polyimide blend being a reinforced polyamide comprising a continuous polyamide phase and a dispersed polyimide phase.

In an embodiment, the disclosure provides a process to produce a reinforced polyamide remarkable in that it comprises:
a) providing components being one or more polyamides, one or more dianhydrides, and one or more diamines; wherein the one or more polyamides are provided at a content of at least 60 wt. % based on the total weight of the components; and wherein the one or more polyamides comprise at least one selected from polyamide 11, polyamide 12, polyamide 12.12, polyamide 10.10, polyamide 10.12, polyamide 11.12 and any mixture thereof;
b) performing in situ synthesis of a polyimide the one or more polyamides by reactive extrusion of the components in a twin-screw extruder comprising a main hopper wherein the screw profile comprises two or more reverse conveying elements forming two or more hot zones to form a polyamide-polyimide blend wherein the residence time is less than 10 minutes; and
c) recovering a polyamide-polyimide blend being a reinforced polyamide comprising a continuous polyamide phase and a dispersed polyimide phase.

More preferably, the disclosure provides a process to produce a reinforced polyamide remarkable in that it comprises:
a) providing components being polyamide 12, one or more dianhydrides, and one or more diamines; wherein the one or more polyamides are provided at a content of at least 60 wt. % based on the total weight of the components;
b) performing in situ synthesis of a polyimide the one or more polyamides by reactive extrusion of the components in a twin-screw extruder comprising a main hopper wherein the screw profile comprises two or more reverse conveying elements forming two or more hot zones to form a polyamide-polyimide blend wherein the residence time is less than 10 minutes; and
c) recovering a polyamide-polyimide blend being a reinforced polyamide comprising a continuous polyamide phase and a dispersed polyimide phase.

Whatever the embodiment, the polyamide-polyimide blend being a reinforced polyamide recovered at step c) further comprises one or more copolymers as evidenced by ¹³C NMR spectra. The one or more copolymers are PA-PI copolymers.

The reinforced polyamide and the process of producing it will be described jointly.

According to the disclosure, in step (a) of the process, the one or more polyamides are provided at a content of at least 50 wt. % based on the total weight of the components; preferably at a content ranging from 50 to 97 wt. %; more preferably from 52 to 95 wt. %; even more preferably, from 55 to 92 wt. %; most preferably from 60 to 90 wt. %.

With preference, in step (a) of the process, the one or more polyamide is provided at a content of at least 60 wt. % based on the total weight of the components; preferably at a content ranging from 60 to 97 wt. %; more preferably from 62 to 95 wt. %; even more preferably, from 65 to 92 wt. %; most preferably from 70 to 90 wt. %.

With preference, the in situ synthesis of a polyimide in the one or more polyamides is performed by adding stoichiometric amounts of dianhydride and diamine.

Polyimides are high-performance polymers with high mechanical strength, they have high glass transition temperatures (Tg: 100 to 350° C.) which allows for keeping the reinforcement properties at high temperatures. Below Tg, there will be a reinforcement of the polyamide due to the rigid dispersed polyimide.

In a preferred embodiment, the two or more reverse conveying elements are selected from kneading left-handed elements and/or left-handed elements.

For example, the two or more hot zones comprise a first hot zone comprises successive kneading blocks elements over a length of at least 4 D followed by a left-handed element with D being the screw diameter, and one or more additional hot zones placed downstream of the first hot zone and being filled mixing zones, each comprising kneading blocks elements over a length of at least 4 D followed by a kneading left-handed element or by a left-handed element with D being the screw diameter.

In an embodiment, step (b) of performing in situ synthesis of a polyimide phase in the polyamide phase by reactive extrusion comprises introducing the polyamide and the dianhydride in the main hopper of the twin-screw extruder and injecting the diamine downstream the first reverse conveying element forming the first hot zone; with preference, at least one additional reverse conveying element forming an additional hot zone is placed at two-thirds of the screw length.

For example, step (b) comprises performing the reactive extrusion with a residence time of less than 10 minutes such as ranging from 10 seconds to less than 10 minutes or from 10 seconds to 9 minutes; preferably with a residence time ranging from 15 seconds to 8 minutes; or with a residence time ranging from 20 seconds to 6 minutes or with a residence time ranging from 20 seconds to 5 minutes; more preferably with a residence time ranging from 10 to 360 seconds or with a residence time ranging from 10 to 240 seconds; even more preferably, from 20 to 180 seconds; most preferably, from 40 to 150 seconds; and even most preferably, from 60 to 120 seconds.

For example, step (b) comprises performing the reactive extrusion with a residence time of at most 9 minutes; preferably, at most 8 minutes; preferably, at most 7 minutes; preferably, at most 6 minutes; preferably, at most 5 minutes; preferably, at most 4 minutes; preferably, at most 360 seconds; preferably, at most 240 seconds; preferably, at most 120 seconds; preferably, at most 110 seconds.

For example, step (b) comprises performing the reactive extrusion with a residence time of at least 10 seconds; preferably, at least 15 seconds; preferably, at least 20 seconds; preferably, at least 25 seconds; preferably, at least 30 seconds; preferably, at least 35 seconds; preferably, at least 40 seconds; preferably, at least 45 seconds; preferably, at least 50 seconds; preferably, at least 55 seconds; preferably, at least 60 seconds; preferably, at least 65 seconds; and preferably, at least 70 seconds.

It is understood that step (b) comprises performing the reactive extrusion at a temperature higher than the melting temperature of polyamide. For example, step (b) comprises performing the reactive extrusion at a temperature ranging from 150 to 250° C.; preferably from 180 to 230° C. These temperatures are the barrel temperatures.

### As Regards the Polyamide

According to the disclosure, the one or more polyamides comprise at least one polyamide having amide groups separated by at least 10 CH₂ groups.

In a preferred embodiment, the one or more polyamides comprise at least one aliphatic polyamide having amide groups separated by at least 10 CH₂ groups.

For example, the one or more polyamides comprise at least one polyamide having amide groups separated by 10 to 12 CH₂ groups. For example, the one or more polyamides are selected from polyamides having amide groups separated by 10 CH₂ groups, polyamides having amide groups separated by 11 CH₂ groups, amide groups separated by 12 CH₂ groups, and any mixture thereof.

For example, the one or more polyamides comprise at least one polyamide selected from polyamide 11, polyamide 12, polyamide 12.12, polyamide 10.10, polyamide 10.12, polyamide 11.12.

For example, the one or more polyamide selected from polyamide 11, polyamide 12, polyamide 12.12, polyamide 10.10, polyamide 10.12, and polyamide 11.12.

With preference, the one or more polyamides are or comprise polyamide 12.

### As Regards the One or More Dianhydrides

In a preferred embodiment, the one or more dianhydrides provided at step (a) are selected from one or more aromatic dianhydrides, one or more aliphatic dianhydrides, and any mixture thereof; preferably, the one or more dianhydrides provided at step (a) are or comprise one or more aromatic dianhydrides.

For example the one or more aromatic dianhydrides are selected from 1,2,5,6-naphthalene tetracarboxylic dianhydride, 1,4,5,8-naphthalene tetracarboxylic dianhydride, 2,3,6,7-naphthalene tetracarboxylic dianhydride, 2-(3′,4′-dicarboxyphenyl) 5,6-dicarboxybenzimidazole dianhydride, 2-(3′,4′-dicarboxyphenyl) 5,6-dicarboxybenzoxazole dianhydride, 2-(3′,4′-dicarboxyphenyl) 5,6-dicarboxybenzothiazole dianhydride, 2,2′,3,3′-benzophenone tetracarboxylic dianhydride, 3,3′,4,4′-benzophenone tetracarboxylic dianhydride (BTDA), 2,2′,3,3′-biphenyl tetracarboxylic dianhydride, 2,3,3′,4′-biphenyl tetracarboxylic dianhydride, 3,3′,4,4′-biphenyl tetracarboxylic dianhydride (BPDA), bicyclo-[2,2,2]-octen-(7)-2,3,5,6-tetracarboxylic-2,3,5,6-dianhydride, 4,4′-thio-diphthalic anhydride, bis(3,4-dicarboxyphenyl) sulfone dianhydride, bis(3,4-dicarboxyphenyl) sulfoxide dianhydride (DSDA), bis(3,4-dicarboxyphenyl oxadiazole-1,3,4) p-phenylene dianhydride, bis(3,4-dicarboxyphenyl) 2,5-oxadiazole 1,3,4-dianhydride, bis 2,5-(3′,4′-dicarboxydiphenylether) 1,3,4-oxadiazole dianhydride, 4,4′-oxydiphthalic anhydride (ODPA), bis(3,4-dicarboxyphenyl) thio ether dianhydride, bisphenol A dianhydride (BPADA), bisphenol S dianhydride, 2,2-bis-(3,4-dicarboxyphenyl) 1,1,1,3,3,3,-hexafluoropropane dianhydride (6FDA), 5,5-[2,2,2]-trifluoro-1-(trifluoromethyl)ethylidene, bis-1,3-isobenzofurandione, 1,4-bis(4,4′-oxyphthalic anhydride) benzene, bis(3,4-dicarboxyphenyl) methane dianhydride, cyclopentadienyl tetracarboxylic acid dianhydride, perylene 3,4,9,10-tetracarboxylic dianhydride, pyromellitic dianhydride (PMDA), 1,3-bis-(4,4′-oxydiphthalic anhydride) benzene, 2,2-bis(3,4-dicarboxyphenyl) propane dianhydride, 2,6-dichloronaphthalene-1,4,5,8-tetracarboxylic dianhydride, 2,7-dichloronaphthalene-1,4,5,8-tetracarboxylic dianhydride, 2,3,6,7-tetrachloronaphthalene-1,4,5,8-tetracarboxylic dianhydride, phenanthrene-1,8,9,10-tetracarboxylic dianhydride, pyrazine-2,3,5,6-tetracarboxylic dianhydride, benzene-1,2,3,4-tetracarboxylic dianhydride; and thiophene-2,3,4,5-tetracarboxylic dianhydride.

With preference, the one or more dianhydrides provided in step a) are or comprise pyromellitic dianhydride (PMDA) 3,3′,4,4′-benzophenone tetracarboxylic dianhydride (BTDA), 3,3′,4,4′-biphenyl tetracarboxylic dianhydride (BPDA), and any mixture thereof.

In a preferred embodiment, the one or more dianhydrides provided in step (a) are or comprise pyromellitic dianhydride (PMDA), 3,3′,4,4′-benzophenone tetracarboxylic dianhydride (BTDA), ant any mixture thereof.

For example, the one or more dianhydrides provided at step (a) are selected from pyromellitic dianhydride (PMDA) 3,3′,4,4′-benzophenone tetracarboxylic dianhydride (BTDA), 3,3′,4,4′-biphenyl tetracarboxylic dianhydride (BPDA), 1S,2R,4S,5R-cyclohexanetetracarboxylic dianhydride (H-PMDA), 1,2,3,4-cyclobutanetetracarboxylic dianhydride (CBDA), bicyclo-[2.2.2]oct-7-ene-2-exo,3-exo,5-exo,6-exo-2,3:5,6-dianhydride (BTA), and any mixture thereof.

With preference, the one or more aliphatic dianhydrides are or comprise 1S,2R,4S,5R-cyclohexanetetracarboxylic dianhydride (H-PMDA), 1,2,3,4-cyclobutanetetracarboxylic dianhydride (CBDA), bicyclo-[2.2.2]oct-7-ene-2-exo,3-exo,5-exo,6-exo-2,3:5,6-dianhydride (BTA), and any mixture thereof. More preferably the one or more aliphatic dianhydrides are or comprise 1,2,3,4-cyclobutanetetracarboxylic dianhydride (CBDA), bicyclo-[2.2.2]oct-7-ene-2-exo,3-exo,5-exo,6-exo-2,3:5,6-dianhydride (BTA), and any mixture thereof. The dianhydrides are commercially available at Sigma-Aldrich.

### As Regards the One or More Diamines

In an embodiment, one or more diamines provided at step (a) are branched aliphatic diamines. For example, the one or more branched aliphatic diamines are selected from trimethyl hexamethylenediamine (TMD), methyl pentamethylenediamine (MPMD), and methyl octamethylenediamine (MOMD). More preferably the one or more branched aliphatic diamines are or comprise trimethyl hexamethylenediamine (TMD). These branched aliphatic diamines are commercially available at large scale and their toxicity is relatively low.

As well known by the person skilled in the art, trimethyl hexamethylenediamine is a mixture of two isomers of trimethyl-1,6-hexanediamine; i.e., it is a mixture of (2,2,4) and (2,4,4) trimethyl hexanemethylenediamine.

### As Regards the Polyamide-Polyimide Blend and the Reinforced Polyamide

The disclosure further provides a reinforced polyamide remarkable in that it comprises a polyamide matrix phase, a dispersed polyimide phase and one or more copolymers, wherein the polyimide of the polyimide phase has a glass temperature transition (Tg) of at least 100° C. as determined by DSC according to the description and is present in a content of from 3 to 50 wt. % based on the total weight of the reinforced polyamide.

In a preferred embodiment, the reinforced polyamide is remarkable in that it comprises a continuous phase, a dispersed polyimide phase, and one or more copolymers wherein the polyimide of the polyimide phase has a glass temperature transition (Tg) of at least 100° C. as determined by DSC and is present in a content of from 3 to 40 wt. % based on the total weight of the reinforced polyamide; preferably a glass temperature transition (Tg) of at least 135° C. as determined by DSC.

According to the invention, the polyamide phase comprises at least one polyamide having amide groups separated by at least 10 CH₂ groups.

The polyimide phase has a glass temperature transition (Tg) of at least 110° C. as determined by DSC; preferably of at least 120° C.; more preferably of at least 130° C.; even more preferably of at least 135° C. or at least 140° C.

For example, the polyimide of the polyimide phase has a glass temperature transition (Tg) ranging from 100° C. to 250° C. as determined by DSC; preferably ranging from 110° C. to 240° C.; more preferably ranging from 120° C. to 230° C.; more preferably ranging from 130° C. to 220° C.; even more preferably, from 135° C. to 210° C.; most preferably ranging from 140° C. to 200° C.; and even most preferably from 150° C. to 200° C.

For example, the reinforced polyamide shows peaks at 29.6, 40.7 and 169.6 ppm on a ¹³C NMR spectra. This is evidence of the presence of a copolymer in the reinforced polyamide.

In a preferred embodiment, the polyimide in the polyamide-polyimide blend recovered in step (c) is an aliphatic-aromatic polyimide. Such aliphatic-aromatic polyimide is obtained using aromatic dianhydrides and aliphatic diamines when producing the polyimide. The use of aliphatic-aromatic polyimide in the reinforced polyamide is favorable for thermal resistance.

In an embodiment, the polyimide in the polyamide-polyimide blend recovered in step (c) has a glass temperature transition (Tg) of at least 100° C. as determined by DSC; preferably of at least 120° C. or at least 135° C.

For example, the polyimide of the polyimide phase (i.e., in the polyamide-polyimide blend recovered in step (c)) has a glass temperature transition (Tg) of at least 110° C. as determined by DSC; preferably of at least 120° C.; more preferably of at least 130° C.; even more preferably of at least 135° C. or at least 140° C.

For example, the polyimide of the polyimide phase has a glass temperature transition (Tg) ranging from 100° C. to 250° C. as determined by DSC; preferably ranging from 110° C. to 240° C.; more preferably ranging from 120° C. to 230° C.; more preferably ranging from 130° C. to 220° C.; even more preferably, from 135° C. to 210° C.; most preferably ranging from 140° C. to 200° C.; and even most preferably from 150° C. to 200° C.

The reinforced polyamide comprises a continuous polyamide matrix phase and a dispersed polyimide phase in the form of dispersed nodules with an average diameter of less than 150 nm as determined by SEM; preferably, of less than 120 nm; more preferably of less than 100 nm.

For example, the average diameter of the polyimide nodules is ranging from 20 to 150 nm as determined by SEM; more preferably ranging from 30 to 130 nm; and even more preferably ranging from 40 to 120 nm; most preferably ranging from 50 to 100 nm; even most preferably, from 60 to 90 nm.

For example, polyimide is present in the reinforced polyamide, at a content of from 3 to 50 wt. % based on the total weight of the reinforced polyamide; preferably from 5 to 45 wt. %; more preferably from 8 to 40 wt. % and even more preferably from 10 to 35 wt. %.

In a preferred embodiment, polyimide is present in the reinforced polyamide at a content of from 3 to 40 wt. % based on the total weight of the reinforced polyamide; preferably from 5 to 35 wt. %; more preferably from 8 to 30 wt. % and even more preferably from 10 to 30 wt. %.

The reinforced polyamide comprises a continuous polyamide matrix phase wherein the polyamide phase is present in the reinforced polyamide at a content of at least 50 wt. % based on the total weight of the reinforced polyamide or at a content of more than 50 wt. %; preferably at a content ranging from 50 to 97 wt. %; more preferably from 52 to 95 wt. %; even more preferably, from 55 to 92 wt. %; most preferably from 60 to 90 wt. %.

With preference, the polyamide phase is present in the reinforced polyamide at a content of at least 60 wt. % based on the total weight of the reinforced polyamide; preferably; preferably at a content ranging from 60 to 97 wt. %; more preferably from 62 to 95 wt. %; even more preferably, from 65 to 92 wt. %; most preferably from 70 to 90 wt. %.

### Methods of Characterization

### Nuclear Magnetic Resonance (NMR)

¹³C liquid-state NMR analyses were performed on a Bruker Avance II spectrometer working at 100.6 MHz with a 10 mm ¹H/¹³C selective probe. The samples were analyzed in HFIP/CDCl₃ (80/20 v/v) at 25° C. with concentrations of 100 mg/mL. The chemical shifts were referenced to tetramethylsilane used as the internal standard (δ=0 ppm).

Fourier-transform infrared spectroscopy (FTIR) ranging from 650 to 4000 cm⁻¹ was recorded on a Nicolet IS10 spectrometer, in attenuated total reflectance (ATR) mode, with 64 scans for each sample

Scanning Electron Microscopy (SEM) observations were carried out on a Quanta 250 electron microscope using an acceleration force of 10 kV and under high vacuum. The specimens were fractured in liquid nitrogen. To contrast the two phases, the samples were stained overnight in an aqueous solution with 2 wt. % of benzyl alcohol and 2 wt. % of phosphotungstic acid (H₃[P(W₃O₁₀)₄]). The phosphotungstic acid preferentially stains the polyamide phase, which appears lighter than polyimide due to the heavy element. The samples were then thoroughly rinsed with distilled water and putter-coated with a 10 nm layer of carbon to ensure a good electrical conductivity between the surface of the sample and the specimen holder.

The average diameter of the nodules was calculated on the SEM images using the ImageJ software.

### Differential Scanning Calorimetry

Thermal properties of the blends were characterized by differential scanning calorimetry (DSC) to study the melting and crystallization behavior using a model Q200 (TA Instruments) equipped with a cooling system 90. Indium was used as a calibration standard. 5 to 10 mg of the samples were weighed and placed into hermetic aluminium capsules. The value of the glass transition temperature (Tg) melting temperature (Tm), crystallization temperature (Tc) and enthalpy were measured on the first cycle applied from 0° C. to 250° C. at a heating rate of 10° C./min under nitrogen. The degree of crystallinity was calculated with the equation as follows:

$${χ}_{c} = \frac{Δ {H}_{m}}{Δ {H}_{m}^{0} ( 1 - Φ )} \qquad Eq . 1$$

Where φ is the weight fraction of PI in blend, ΔHm is the sample melting enthalpy and ΔHm0 is the melting enthalpy of 100% crystalline PA-1 (ΔHm0 PA-12=233.5 J/g).

### Rheological Behavior

Dynamic frequency tests were conducted on a strain-controlled Discovery Hybrid Rheometer DHR (TA Instruments) using a parallel plate geometry (25 mm diameter, 2 mm gap). Measurements were performed at 230° C. under a nitrogen flow to prevent thermal degradation. The complex shear modulus was then measured (storage modulus G′(ω) and loss modulus G″(ω)) by varying the frequencies from 100 to 0.1 rad/s in the linear regime.

### X-Ray Diffraction: Wide Angle X-Ray Scattering (WAXS)

The measurements were carried out at the European Synchrotron Radiation Facility (ESRF, Grenoble, France) on the D2AM beamline. The incident photon energy was set at 16 keV and two 2D detectors were simultaneously used: D5 for SAXS and IMXPAD WOS-S700 for WAXS measurements. The sample-to-detector distance was about 1.13 m for SAXS and 9.74 cm for WAXS and the beam stop had a 1 mm diameter. The SAXS and WAXS q-calibrations were achieved using silver behenate and lanthanum hexaboride standards, respectively. The intensity calibration was performed using a glassy carbon standard. Each sample was hot pressed into a 200 to 300 μm thick film without any preferential orientation and placed into sample holders. The intensity from the samples was obtained by taking into account the detector geometry and flat-field response, by normalization from the thickness and attenuation of the samples and by subtraction of the intensity of the empty cell. The corrected two-dimensional data were averaged azimuthally to obtain intensity I vs scattering vector q (q=(4π/λ)·sin(θ), where 2θ is the scattering angle and λ is the incident wavelength).

### Tensile Testing

Uniaxial tensile tests were performed on a Shimadzu AG-X+ tensile testing machine equipped with a load cell of 10 kN at room temperature. To comply with ISO-1874-2 standard, each blend was tested at a speed of 50 mm/min to measure yield stress and strain at break and at 1 mm/min to determine Young's modulus At least 10 different samples were tested for each formulation.

All specimens were tested twice: dry (as molded) and conditioned in a controlled humidity environment. Test specimens for dry testing were put in a hermetic bag directly after injection molding. The other specimens were stored in a climate chamber at 40° C. and 80% relative humidity. The samples were weighed before humidity exposure and were removed from the chamber when the water uptake reached its equilibrium after 40 h (0.7 wt. % for PA-12 [2]).

Residence time is determined using colored pellets of polymer. The colored pellets are introduced in the extruder by the main hopper and the time for colored material to appear at the die exit of the extruder is measured. The measured time is the residence time.

### EXAMPLES

### Selection of the Materials

The polyamide-12 matrix Rilsamid® AESNO TL with a melt flow index of 8 g/10 min (at 235° C., 5 kg), a zero shear viscosity η₀=5000 Pa·s at 230° C. and a viscosity of 4000 Pa·s at the frequency of 1 rad/s, was purchased from Arkema as polymer pellets. Pyromellitic dianhydride (PMDA) and trimethylhexanemethylenediamine (TMD) were purchased from TCI Chemicals and used as received. 1,1,1,3,3,3-Hexafluoro-2-propanol (HFIP), chloroform-d and tetramethylsilane were purchased from Sigma Aldrich and used as received.

Table 1 depicts the main characteristics of these materials.

TABLE 1
Main physical and chemical characteristics of the materials

| Name | | Tₘ | T_{B} | Density |
|---|---|---|---|---|
| (Commercial Name) | M (g/mol) | (° C.) | (° C.) | (g/cm³) |
| PA-12 | Mn: 26,000 | 180 | / | 1.01 |
| (Rilsamid AESNO TL) | Mw: 47,000 | | | |
| PMDA | 218 | 285 | 400 | 1.68 |
| (Pyromellitic dianhydride) | | | | |
| TMD | 158 | −80 | 232 | 0.87 |
| (Trimethylhexanemethylene- | | | | |
| diamine) | | | | |

### Synthesis of Polyimides in Solution

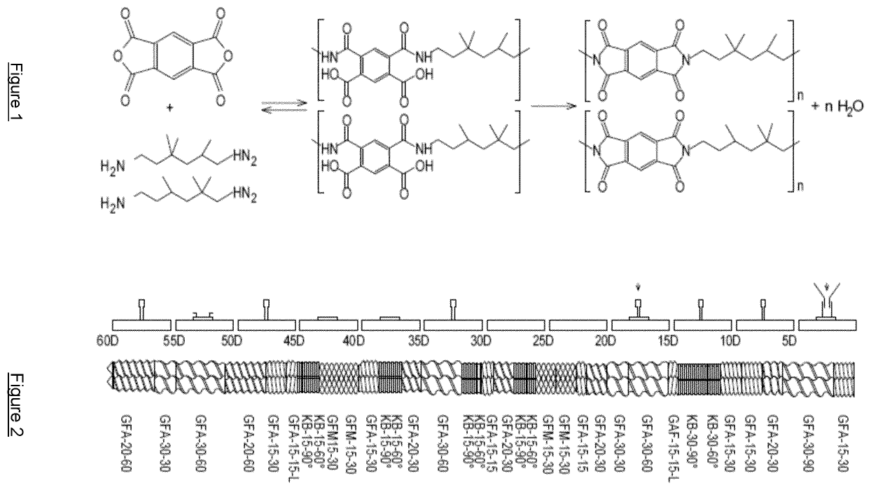

The polyimides were synthesized in solution from two non-toxic monomers. Pyromellitic dianhydride (PMDA) is a commercial dianhydride commonly used for the synthesis of Kapton® and well known to confer a highly rigid structure to the resulting polymers (Tg=385° C. and Td,5%=608° C. for Kapton®). A mixture of (2,2,4) and (2,4,4) trimethylhexane methylene diamine (TMD), two flexible aliphatic diamine isomers produced by Evonik were chosen as comonomers. The incorporation of these diamines in the polyimide structure (displayed in FIG. 1) was expected to bring flexibility to the polymer chains.

In a three-neck round bottom flask equipped with a nitrogen inlet and a mechanical stirrer, an equimolar amount (13.75 mmol) of dianhydride and diamines were suspended in 12 mL of m-cresol (30 wt. %). The reaction mixture was heated at 180° C. for 6 h. The highly viscous solution was poured into methanol. The fibrous polymer was isolated by filtration and crushed. After purification by Soxhlet extraction with methanol, the polymer was dried overnight under a vacuum at 80° C.

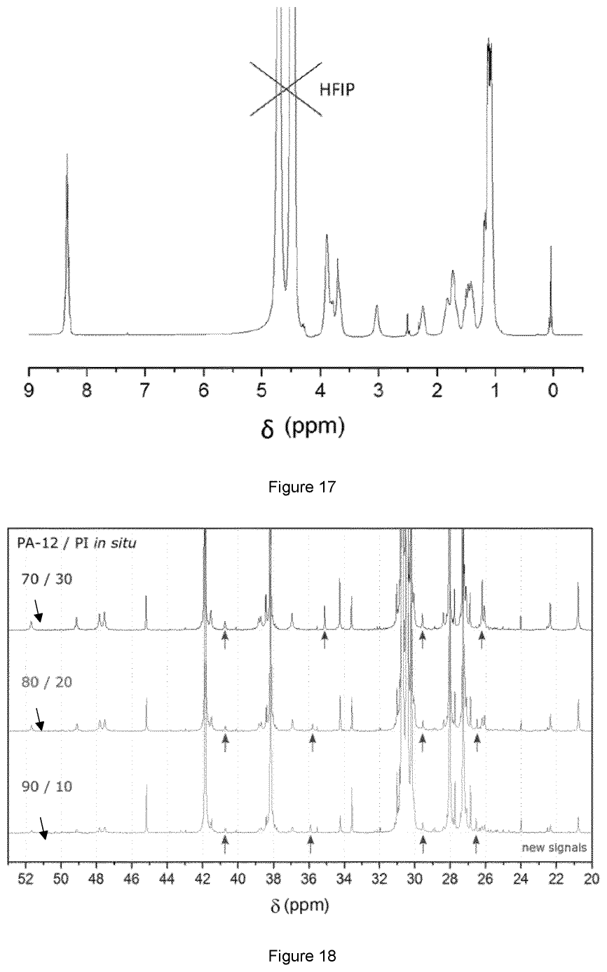

An amorphous polyimide was synthesized with a glass transition temperature evidenced at 150° C. by Differential Scanning Calorimetry. The Fourier transform infrared spectroscopy (FTIR) spectrum confirmed the full imidization, with the presence of the characteristic imide bands, at 1700 and 1770 cm⁻¹ for the C═O bond and 1370 cm⁻¹ for the C—N bond (displayed in FIG. 16). Moreover, ¹H NMR revealed only one peak at 8.3 ppm for the aromatic ring hydrogens, further confirming the full imidization. ¹³C NMR analysis was also performed to analyse the polyimide structure; the complete assignments of the signals will be detailed in the discussion below (see FIG. 17).

### Synthesis of PA-12/PI Blends

### Melt Blending in a Microextruder

As a comparative example, a PA-12/PI 70/30 wt. % blend was prepared by melt blending in an Xplore DSM vertical microextruder equipped with twin conical screws. The polyimide incorporated in the blend was the one previously synthesized in solution and then added to the polyamide matrix. The rotation speed was set at 100 rpm, the temperature at 240° C. and the mixing time at 5 min.

### In Situ Synthesis by Reactive Extrusion

Different PA-12/PI blends were synthesized in a co-rotating twin-screw extruder (Leistriz ZSE18HPe-60D model, diameter 18 mm, L/D=60) at 230° C. and screw speed of N=600 rpm. The twin-screw profile is shown in FIG. 2. It particularly contains two reverse conveying elements: the first one is positioned (L/D=15) upstream of the diamine injection (L/D=17.5) to avoid the liquid from rising out, and the second one is positioned (L/D=45) at two-thirds of the extruder to create a plug upstream of the evaporation of the volatiles.

Different polyimide contents were synthesized in situ in the polyamide matrix by adding stoichiometric amounts of dianhydride and diamine. The flow rates of the different components were adapted for every formulation to maintain a total extrusion flow rate of Q=3 kg/h. A description of all the formulations is referenced in Table 2. PA-12 and PMDA were incorporated by the main hopper, whereas TMD was incorporated in the matrix in the molten state at the injection point L/D=17.5 using an external liquid pump. The barrel elements at L/D=37.5 and L/D=57.5 were kept open to evaporate the water generated during the polycondensation reaction. The mean residence time of the polymer in the extruder was calculated at 90 s under these processing conditions using the Ludovic software. At the die exit of the extruder, samples were cooled down with air and granulated.

TABLE 2
Blend compositions in weight %

Composition in wt. %

| | PA-12 | PI |
|---|---|---|
| PA-12/PI | 100 | 0 |
| in situ blends | 90 | 10 |
| | 80 | 20 |
| | 70 | 30 |
| PA-12/PI | 70 | 30 |
| simple melt blending * | | |

* microextruder (batch mixer), Vol: 50 Cm³, N = 50 rpm, T = 230° C.

After extrusion, the pellets of the different blends were injected in a hydraulic injection molding machine Battenfeld UNILOG B2 6/10P equipped with a 60 mm diameter piston and presenting a clamping force of 350 kN. Injected samples were either dog-boned shaped 1BA samples for tensile testing or pieces with a length of 75 mm, a width of 10 mm and a thickness of 4 mm for impact testing. The chamber temperature was set at 230° C., mold temperature at 60° C. and the injection pressure was adapted to each sample to provide an optimal filling of the mold. For rheological measurements, cylindrical samples (25 mm in diameter, 2 mm thick) were hot pressed at 240° C. under 200 bars for 2 min.

### Morphology Development

First, two processing ways for the preparation of PA-12/PI blends were studied and compared. The first blend was prepared by reactive extrusion in a twin-screw extruder, with the in situ synthesis of the PI phase in the PA-12 matrix. The second blend was prepared by classical melt blending in a microextruder from the addition to the PA-12 of the preformed PI phase previously synthesized in solution. The morphology of the blends prepared by the two different routes is compared.

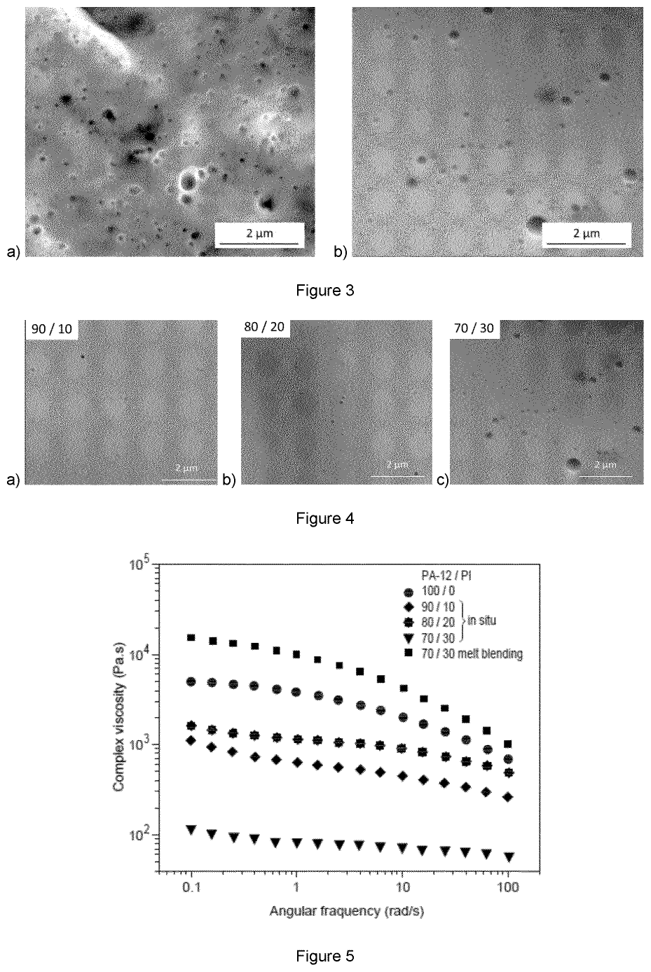

Scanning Electron Microscopy (SEM) images are shown in FIG. 3. The PA-12 matrix appears brighter than PI due to the phosphotungstic acid treatment of the samples. Whereas both blends exhibit a nodular homogeneous dispersion of the polyimide phase in the polyamide matrix, the diameter of the polyimide nodules is far smaller when the polyimide is synthesized during the extrusion process. The PA-12/PI 70/30 wt. % blend made through classical melt blending displays a broad PI particle distribution ranging from 50 nm to 1 μm, with a mean value of 170 nm (±110 nm) and presenting a very high standard deviation. Indeed, as can be noticed in FIG. 3a, some polyimide nodules are much bigger than the other average nodules in the blend. On the opposite, the blend prepared by in situ PI synthesis presents polyimide nodules with a diameter ranging from 20 to 300 nm, with a mean value of 65 nm (±40 nm). This in situ reactive blending way presents the advantage of leading to a finer and more uniformly dispersed morphology.

Based on this approach, different proportions of polyimide were synthesized in situ in a PA-12 matrix. The resulting blend morphologies are shown in FIG. 4. In all cases, the polyimide phase appears uniformly dispersed in the polyamide matrix. The nodules form nanometer domains, with a diameter distribution ranging from 20 to 150 nm, with a mean value of around 50 nm for the three blends. The nodule diameters are detailed for each PI concentration in Table 3. The SEM analyses suggest that the polyimide nodules have good adhesion with the polyamide matrix, as no void is visible between the nodules and the matrix.

TABLE 3
Mean diameter D of PA-12/PI (wt. %) in situ blends

| PA-12/PI (wt. %) | D (nm) |
|---|---|
| 90/10 | 55 ± 35 |
| 80/20 | 65 ± 15 |
| 70/30 | 70 ± 60 |

Besides the morphology evolution, the viscosity of the PA-12/PI in situ blends highly decreased compared to the PA-12 matrix alone (FIG. 5). Indeed, PA-12 's viscosity at 1 rad·s is around 4000 Pa·s, it decreases to 1,000 Pa·s for blends with 10% of PI, to 60 Pa·sd for blends with 20 wt. % of PI, and finally to 80 Pa·s for blends with 30 wt. % of PI. On the contrary, the PA-12/PI 70/30 blend prepared by simple melt blending displays a higher viscosity (10000 Pa·s) than virgin PA-12, due to the incorporation of the pre-synthesized polyimide.

The very fine dispersion of the polyimide phase in polyamide combined with the viscosity decrease suggests that there are specific reactions between PA-12 and the in situ synthesized PI which is not observed when the blend is prepared by melt process. It is well accepted that in a polymer blend, the presence of copolymers at the interface helps to reduce the interfacial tension between the two phases, favors the formation of small particle size, and prevents their coalescence. Moreover, a decrease in viscosity might imply chain scission or the formation of branches, both of which result from a chemical reaction between the two phases.

To argue such a hypothesis, it is then important to study the reactions between the polyamide and the polyimide phases occurring at high temperatures for both preparation approaches. In that frame, liquid-state ¹³C NMR analyses of the blends were performed to evidence the chemical structures of the materials. The assignment of the peaks was based on literature data, DEPT additional experiments, as well as on chemical shift predictions determined from ACD/Labs Software (Advanced Chemistry Development).

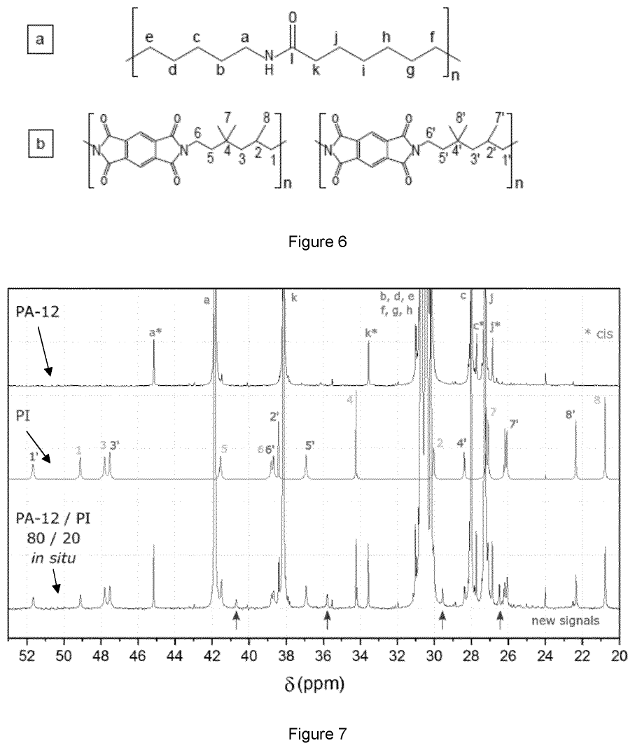

FIG. 6 shows the structures of polyamide-12 and the two expected polyimide sequences with the labeling used for the signal's attribution. PA-12 is mainly in its trans-configuration, but NMR analyses also attest to the presence of a small amount (<5%) of cis-configuration. The peaks associated with this minor form are noted on the NMR spectrum with a *.

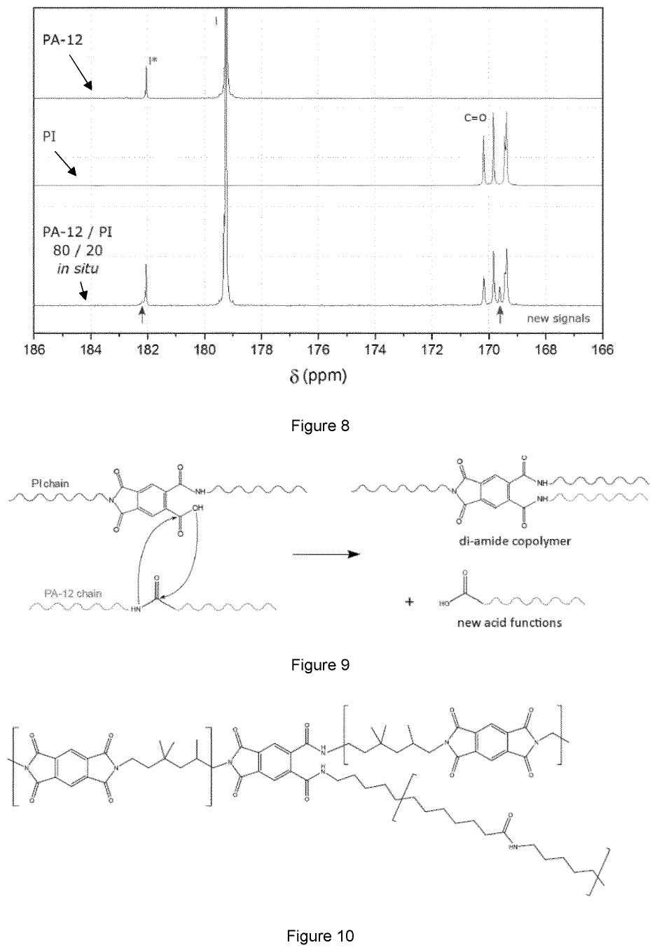

¹³C NMR spectra of PA-12, PI, and PA-12/PI 80/20 wt. % in situ blend are displayed in FIG. 7 and FIG. 8. The polyamide-12 spectrum displays methylene signals between 26 and 46 ppm evidencing its main trans-configuration. Additional minor peaks allow estimating less than 5% of cis-conformation in PA-12. The amide carbonyl signal of PA-12 is found at 179 ppm. Methylene carbon of amine end groups was detected at 43.2 ppm, and carbonyl of carboxylic acid end groups at 182.7 ppm.

The polyimide spectrum exhibits many signals for each functional group, due to the incorporation of the two diamine isomers. The carbons of the aliphatic chains coming from TMD are all observed between 20 and 52 ppm. Carbons of the aromatic ring and carbonyls were all observed as multiple signals around 140 ppm (not shown) and 170 ppm respectively.

As expected, the PA-12/PI 80/20 wt. % in situ blend NMR spectrum displays most signals characterizing both PA-12 and PI structures, confirming that polyimide was effectively formed in situ during the extrusion process. The presence of the 4 carbonyl imide groups in particular attests to a complete imidization reaction in these conditions. However, slight differences can be observed.

First, six new signals were observed on the ¹³C spectra, that are not present either in PA-12 or PI's chemical signatures. DEPT-135 analyses enabled the identification of four methylene carbons (at 26.5 ppm, 29.6 ppm, 35.8 ppm, and 40.7 ppm) and two carbonyl groups (at 169.6 ppm and 182.2 ppm).

Considering the reactive functional groups susceptible to react (amine or anhydride groups) either present on the incorporated monomers, as PA-12 chain ends, or as polyimide telechelic groups; the formation of new imide or amide linkages might be envisioned. If only the reactions between PA-12 chain ends and anhydrides or amines of the introduced monomers are considered, the newly generated peaks would have a signal of low intensity, equivalent to those of PA-12 chain ends. However, the intensities of the six new signals identified are much more important than those of PA-12 chain ends and thus suppose that the new peaks come from another reaction. One possible explanation that could account for the presence of the 6 new signals relies on a carboxylic acid/amide exchange between the poly(amid acid) formed in situ and PA-12.

As represented in FIG. 9, this reaction might generate two new amide groups: one from poly(amic acid) after the reaction between PMDA and TMD, and one from the reaction of the carboxylic acid function with the amid groups of PA12. This reaction should be characterized by at least two new signals for the CH₂ in the alpha and beta position of the NH group as well as a new carbonyl for each amide. Besides, an increase in the contribution of acid terminal groups should also be observed, resulting from these transreactions. One could therefore expect the increase of three peaks, corresponding to the carbonyl of the acid function as well as the CH₂ in its alpha and beta position.

Among the six new peaks identified, three of them correspond to the terminal acid functions of PA12 chains (26.5, 35.8, and 182.2 ppm). The three remaining peaks are associated with the new amide function created by the reaction between the carboxylic acid of in situ formed polyacid amide and the amide group of PA-12 (29.6, 40.7, and 169.6 ppm). A simulation of the chemical shifts for this copolymer structure on the ACD/Labs software gave a very good correlation of the theoretical values with the experimental data.

However, the peaks corresponding to the amide function from TMD were not identified. Simulations on the ACD software gave a similar chemical shift for the carbonyl function for both amides from PA-12 and TMD, both peaks could therefore be overlaid. As four different combinations of diamine copolymer groups can be expected due to the isomeric structure of TMD, signals depicting such an amide structure are expected to be multiple with small intensities. We suppose that those signals are hidden by PA-12 and PI peaks, making them undetectable.

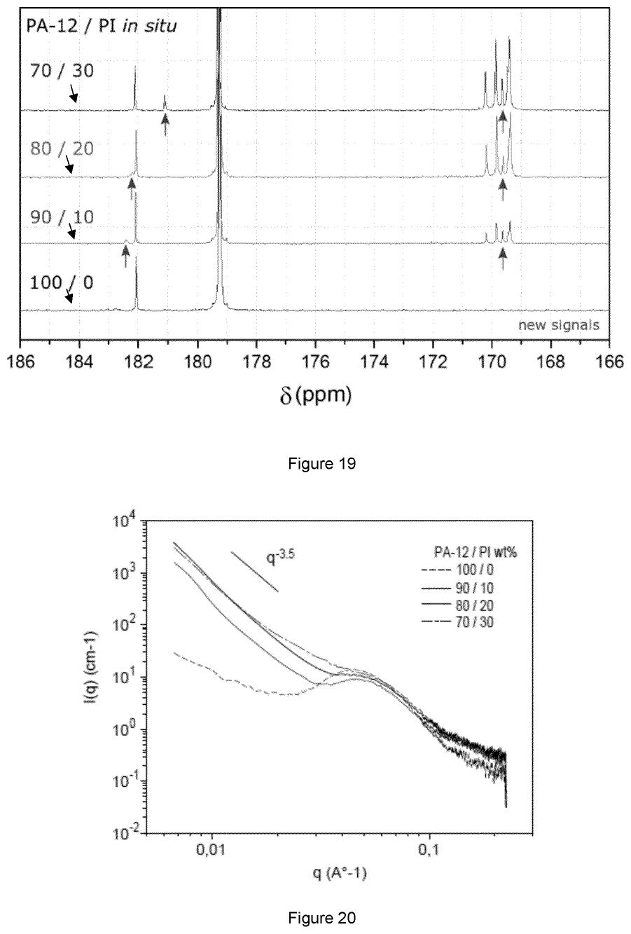

Whatever the polyimide content synthesized in situ in PA-12, the ¹³C NMR characterization of all blends are similar and displayed the six new peaks characterizing the copolymer formation. Although the NMR studies were not quantitative, it was possible to evidence that the intensities of the six peaks increased with the polyimide content (spectrum available in FIGS. 18 and 19). Moreover, slight differences in the chemical shifts can be observed (Table 4) for the carbons of the PA-12 terminal acid functions. The higher the polyimide concentration, the more shielded the signals will be. This could be due to the higher concentration of carboxylic acid groups which are highly susceptible to forming hydrogen bonds within the material, leading to shifts in their characteristic NMR signals.

TABLE 4
Chemical shifts (ppm) of the new chemical bonds
created during the copolymer formation

| PA-12/PI | | | | | |
|---|---|---|---|---|---|
| (wt. %) | α (NHCO) | β (NHCO) | CONH | α (COOH) | β (COOH) |
| 90/10 | 40.7 | 29.6 | 182.4 | 35.9 | 26.5 |
| 80/20 | 40.7 | 29.6 | 182.2 | 35.8 | 26.5 |
| 70/30 | 40.7 | 29.6 | 181.1 | 35.1 | 26.2 |

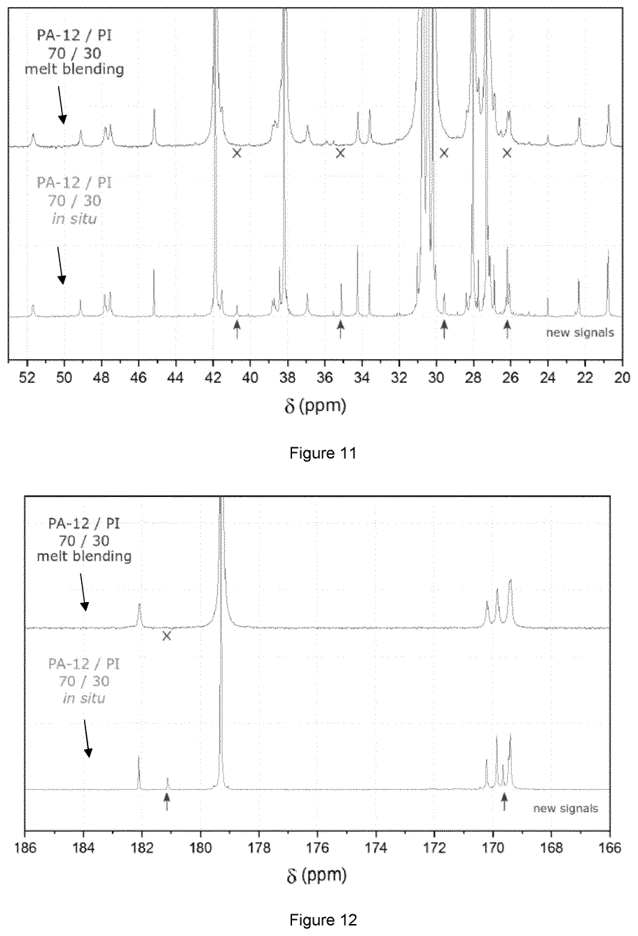

To confirm that the formation of this new copolymer results from the reaction between poly(amic acid) groups of the growing polyimide and amide groups of PA-12 during the reactive extrusion process, a similar blend was prepared by melt blending the two pre-existing polymers. As expected, in this case, no signals associated with the formation of a new copolymer could be evidenced in the spectrum of the material (FIG. 11 and FIG. 12). Indeed, without the formation of poly(amic acid) during the process, no reaction with the amide groups occurs.

These results are consistent with the viscosity of the blends reported above in FIG. 5. The transamidation reactions may therefore explain the decrease in viscosity in the in situ blends, either by chain scission or by the creation of branched structures. On the contrary, no reaction is observed in the case of simple melt blending, as the viscosity increases due to the incorporation of the PI phase.

Such reaction between an acid group and an amide function has been described only a few times in the literature, and mostly in the case of polyamide/polyamide blends. Puglisi and Samperi in “Structural characterization of copolyamides synthesized via the facile blending of polyamides” (Macromolecules, 2004. 37(17): p. 6449-6459) studied the exchange reactions occurring in PA-6/PA-6,10 blends with a carboxylic acid terminated Nylon 6 (PA-6-COOH). The equimolar blends were melt-mixed at 310° C. in a glass vessel under a nitrogen stream for 60 to 180 min. They concluded through ¹³C NMR and MALDI studies that acidolysis reactions are happening between PA-6-COOH and the amide groups of PA-6,10.

However, this reaction via a poly(amic acid) intermediate has never been reported in the case of polyamide blends. As discussed above, this reaction is only possible when the polyimide is synthesized in situ in molten PA-12 by reactive extrusion. This reaction allows the formation of copolymers directly at the interface, which reduces the interfacial tension between the two phases and leads to a very fine dispersion of polyimide nodules.

### Mechanical Properties

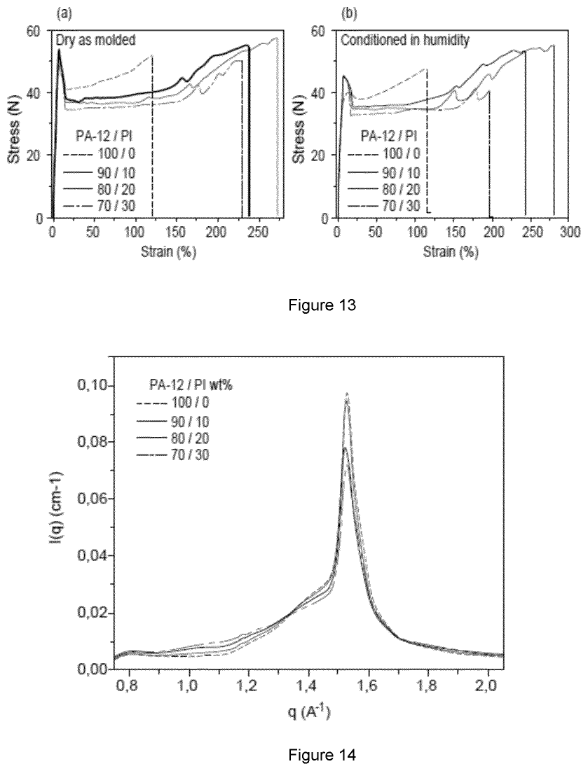

The mechanical properties of the PA-12/PI blends were investigated by tensile tests; the results are reported in Table 5 and the tensile curves are displayed in FIG. 13. To study the influence of water uptake on the properties of the materials, tensile tests were performed on dry as molded (DAM) samples and humidity-conditioned (WET) samples.

It is well known that polyamides are sensitive to water absorption. Indeed, the polar amide groups can bind with water through hydrogen bonds. Water is known to act as a plasticizer in the polymer matrix, and will most of the time result in a decrease of the Young's modulus and an increase of the strain at break. Such a phenomenon was observed for pure PA-12. Indeed, its Young's modulus decreased by 20% when the samples were conditioned in humidity (with a 0.7% water uptake). However, in our case, its strain at break was not modified.

For the dry samples, the Young's modulus of the PA-12/PI blends prepared by the in situ synthesis of the PI phase is the same as of pure PA-12. Surprisingly, the results show that the presence of a PI phase prevents the humidity effect on PA12. Indeed, as it can be seen on table 5, in any case, wet PA12/PI samples have a higher Young modulus than PA12 (dry condition).

The higher the PI content is, the higher the Young's modulus is, with an improvement from +10% to +20% compared to pure PA-12 depending on the polyimide concentration. For these samples, the presence of polyimide increases the Young's modulus of the material which overtakes the decrease of the Young's modulus of the PA-12 matrix from the water uptake.

For all blends, DAM or WET, there is an increase in the yield stress and the maximal stress when polyimide is added to PA-12. In addition, the necking region of the material was extended with the addition of in situ synthesized polyimide. As displayed in FIG. 13, the stress is steady for a longer time after yield compared to pure PA-12, and strain hardening of the blends is delayed compared to the PA-12 matrix alone. There is also a significant increase in the strain at break, for both samples conditioning. The value of the strain at break is more than doubled in the presence of in situ synthesized polyimide. However, for the blend prepared by simple melt blending, the material breaks rapidly with a strain at break of only 5%, indicating a poor interface between the two polymers. The increase in strain at break for the PA-12/in situ synthesized PI blends could be explained by the very fine dispersion of the polyimide nodules in the matrix. It also comes from the new copolymer creation at the interphase of both phases (PA12 and PI) in the material, which stabilizes the interface of the two polymers and prevents crack propagation between the PI nodules and the PA-12 matrix which interface could act as defects in the material and lead to mechanical failure. The mechanical properties of the blends could also come from the crystallinity of the material.

TABLE 5
Mechanical properties of the in situ and melt blended PA-12/PI blends

| | | | Young | Yield | Maximal | Strain |
|---|---|---|---|---|---|---|
| | PA-12/PI | | Modulus | Stress | Stress | at Break |
| | (wt %) | Process | (MPa) | (MPa) | (MPa) | (%) |
| DAM | 100/0 | / | 1300 ± 30 | 50 ± 1 | 52 ± 1 | 120 ± 10 |
| | 90/10 | In situ | 1300 ± 30 | 53 ± 1 | 57 ± 2 | 260 ± 20 |
| | 80/20 | In situ | 1400 ± 25 | 52 ± 1 | 57 ± 2 | 240 ± 20 |
| | 70/30 | In situ | 1400 ± 10 | 53 ± 1 | 53 ± 1 | 230 ± 10 |
| | 70/30 | Melt | 1700 ± 20 | 41 ± 5 | 41 ± 5 | 5 ± 1 |
| | | blending | | | | |
| WET | 100/0 | / | 1100 ± 50 | 40 ± 1 | 47 ± 2 | 120 ± 10 |
| | 90/10 | In situ | 1200 ± 40 | 45 ± 1 | 56 ± 5 | 280 ± 40 |
| | 80/20 | In situ | 1300 ± 30 | 46 ± 1 | 54 ± 2 | 240 ± 10 |
| | 70/30 | In situ | 1300 ± 30 | 46 ± 1 | 48 ± 2 | 200 ± 30 |

### Crystallinity and Structural Organization

A complete study of the polymer crystallinity can sometimes give information on the material properties. Indeed, it has been reported that the degree of crystallinity, the nature of the crystalline phase and the size of the crystallites can influence the mechanical properties. The crystalline parameters of the PA-12/PI blends were investigated with different techniques. First, Differential Scanning Calorimetry (DSC) measurements were carried out to calculate the degree of crystallinity of the blends. Wide Angle X-ray Scattering (WAXS) was used to access the crystalline forms present in the different blends. Small Angle X-ray Scattering (SAXS) measurements were also performed to obtain crystalline information, i.e. the lamellae thickness and composition.

The thermal properties Tg, Tm, Tc and the degree of crystallinity Xc of PA-12 obtained by DSC are depicted in Table 6. The heat flow variations between the glassy and rubbery state of PI are too small to be noticed on the thermograms, only the transitions of PA-12 can be observed. It can first be noticed that the in situ synthesis of the polyimide phase in the PA-12 does not modify significantly the crystallinity parameters of the polyamide matrix. The glass transition temperature of PA-12 is constant for all blends, with a value of around 36° C. Moreover, the presence of polyimide does not alter the degree of crystallinity of the polyamide phase, which maintains a value of about 25% for all blends. The crystallization temperature was decreased by 10° C. for all PA-12/PI in situ blends, which indicates a lower crystallization rate of the blends.

TABLE 6
Thermal properties of the PA-12/PI in situ blends obtained by DSC

| PA-12/PI | Tg (PA12) | Tm (PA-12) | Tc (PA-12) | Xc |
|---|---|---|---|---|
| (wt. %) | (° C.) | (° C.) | (° C.) | (%) |
| 100/0 | 35.4 | 171.3 | 150.4 | 25.3 |
| 90/10 | 36.2 | 176.2 | 141.1 | 24.5 |
| 80/20 | 36.7 | 175.5 | 138.1 | 25.4 |
| 70/30 | 36.6 | 175 | 139.4 | 26.6 |

To further analyze the impact of the in situ creation of the polyimide phase in the polyamide-12 matrix, a specific study by Wide Angle X-ray Scattering (WAXS) was performed. The WAXS patterns of pure PA-12 and the different PA-12/PI in situ blends are displayed in FIG. 14. The WAXS patterns of semi-crystalline polymers exhibit an amorphous halo and intense reflections due to the crystalline fraction. Pure PA-12 usually crystallizes in the γ-form, characterized by the planes (002)γ, (004)γ and (001)γ. This hexagonal γ-form is the most common crystalline structure of polyamide-12 and has the highest thermodynamic stability. In this form, the chains are aligned parallelly and the chains are slightly twisted to allow hydrogen bonding between the amide groups. The deconvolution of those diffractograms is very difficult as the crystalline peaks are superimposed with the amorphous halo. However, it can be noticed that the PA-12/PI WAXS profiles are essentially identical to the ones of pure PA-12. It means that the in situ synthesis of the polyimide phase does not modify the crystalline phases of PA-12. In the diffraction pattern of PA-12 and the PA-12/PI in situ blends, the diffraction maximum observed at q=1.52 Å-1, corresponding to the (001)γ plane, as well as the small bump at q=0.85 Å-1, corresponding to the (040)γ plane, are characteristic of the γ-crystalline form.

Small Angle X-ray Scattering (SAXS) experiments were also performed to access the small-scale morphology of the materials (1 to 100 nm). These analyses allow access to the crystalline parameters of the material. Indeed, semi-crystalline polymers like polyamide manifest a lamellar morphology consisting of an alternance of lamellar crystals with a characteristic thickness lc and amorphous regions with a thickness la. Binary polymer blends (A/B, where A is a semi-crystalline polymer and B is an amorphous polymer) can display crystals of A dispersed in the amorphous phase of B, or the growth of spherulites of A can happen in the B matrix. In the latter case, the amorphous B phase may be located in the interspherulitic region, interfibrillar regions, interlamellar regions or a combination of these regions. Semi-crystalline polymers or their blends with an amorphous polymer are defined by two characteristic lengths, lc and la, where Lp=la+lc is the long period of the crystallinity, usually around 10 nm.

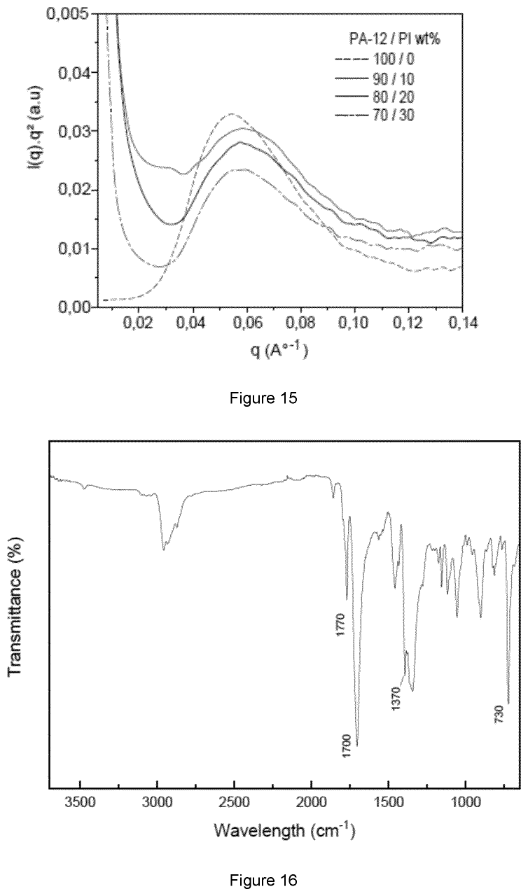

The materials characterized by SAXS and WAXS experiments were not oriented, and the intensity presented a circular symmetry around the axis of the direct beam. FIG. 15 shows the Lorentz-corrected SAXS profiles of PA-12 and PA-12/PI in situ blends. From this graph, representing I(q)×q² versus q, the long period also called the interlamellar spacing can be calculated using Bragg's law (Eq 2), from the maximum peak abscissa (qmax) of the curve:

$${L}_{p} = \frac{2 π}{{q}_{max}} \qquad Eq . 2$$

From the long period, the thickness of the amorphous and crystalline lamellae can be calculated from those equations, where Xc was obtained by DSC:

$${l}_{c} = {L}_{p} \cdot {χ}_{c} \qquad Eq . 3$$

$${l}_{a} = {L}_{p} \cdot ( 1 - {χ}_{c} ) \qquad Eq . 4$$

The calculations were made assuming that the sample consists only of an amorphous-crystalline stack structure, that the amorphous phase is only intraspherulitic and that each lamellae are homogeneous. The different parameters calculated from SAXS measurements are displayed in Table 7.

Pure PA-12 exhibits a typical scattering profile, with a broad peak which is characteristic of the amorphous-crystalline lamellae alternance in the polymer. PA-12/PI reactive blends display different scattering patterns, with an abrupt increase of intensity in the low q region. The intensity is more pronounced when there is more polyimide in the material. This large intensity at low q is attributed to the presence of heterogeneities whose size is larger than the crystalline and amorphous layers. This increase is due to the presence of polyimide nodules, which are objects located outside of the polyamide spherulites. In Formation of Segregation Morphology in Crystalline/Amorphous Polymer Blends: Molecular Weight Effect. Macromolecules, 1998. 31(7): p. 2255-2264, Chen and Hsiao observed the same phenomenon in binary blends of poly(ethylene terephthalate) (PET) and poly(ether imide) (PEI) prepared by solution precipitation in phenol/tetrachloroethane (60/40 v/v) at 80° C. During blending, liquid-liquid demixing led to PEI-rich domains, which resulted in an increase of the intensity in the low q region. Moreover, the SAXS patterns I(q)=f(q) in FIG. 20 display a −3.5 slope, which suggests the presence of a biphasic system with a rough or inter-diffuse interface. This non-frank interface supports the fact that copolymers are formed at the interface of the two polymers.

Table 7 contains the crystalline parameters of PA-12 and the different PA-12/PI in situ blends. As described earlier, the degree of crystallinity of PA-12 is not modified with the in situ synthesis of the polyimide phase. However, the long-period Lp of PA-12/PI blends is slightly decreased compared to the one of pure PA-12. The long period decreases from 113.2 Å for pure PA-12 to 105.5 Å in presence of 30 wt. % of PI in the material, meaning that the incorporation of polyimide affects the crystalline parameters of PA-12. The crystalline lamellae thickness is constant at around 27 nm for all PI contents, but the amorphous lamellae become thinner with the addition or more polyimide to the blend. Indeed, la reduces from 84.6 nm for pure PA-12 to 77.4 nm for the PA-12/PI 70/30 wt. % blend.

TABLE 7
Values of Xc obtained by DSC and Lp, lc, la measured by
SAXS for pure PA-12 and the PA-12/PI in situ blends

| PA-12/PI (wt. %) | Xc (%) | Lp (Å) | Lc (Å) | La (Å) |
|---|---|---|---|---|
| 100/0 | 25.3 | 113.2 | 28.6 | 84.6 |
| 90/10 | 24.5 | 107.7 | 26.4 | 81.3 |
| 80/20 | 25.4 | 106.9 | 27.2 | 79.8 |
| 70/30 | 26.6 | 105.5 | 28.1 | 77.4 |

### CONCLUSION

The in situ synthesis of a polyimide dispersed phase in a polyamide-12 matrix led at the same time to the in-situ creation of copolymers at the interface. This reaction was studied in detail by ¹³C NMR experiments and showed that the poly(amic acid) intermediate during polyimide synthesis reacts with amide groups on PA-12 chains. This copolymer formation led to a very fine dispersion of polyimide nodules in the PA-12 matrix, with diameters around 70 nm. Moreover, these transamidation reactions resulted in a decrease in the blends' viscosity, due to either chain scission or the creation of a branched structure.

In addition to the reduction of viscosity, the mechanical properties of the different blends were increased. Thus, a better balance of properties is obtained since the decrease of the viscosity while increasing or at least maintaining the mechanical properties is extremely important from a processing point of view. A lower viscosity means a lower energy consumption in processing, injection moulding for example.

The Young's modulus showed no improvement for dry samples but was increased up to 20% for humidity-conditioned samples containing 30 wt. % of PI. So, it could be said that the in situ PI phase prevents water degradation. In addition, the strain at break was highly improved, with the value more than doubled for all PA-12/PI in situ blends compared to pure PA-12.

The crystallinity parameters of the materials were also investigated. The degree of crystallinity of the PA-12 semi-crystalline phase stayed constant with the addition of polyimide, but other crystalline parameters were modified such as the long period Lp and the thickness of the amorphous lamellae la. The diminution of these thicknesses in the presence of polyimide in the blend could explain the lower mobility of the amorphous phase and therefore the increase of the Young's modulus and the yield stress of the blends.

In conclusion, a reinforced polyamide is disclosed. For example, for the PA-12/PI blends, the Young's modulus was either stable for dry samples or increased by +20% for humidity-conditioned samples. The strain at break was more than doubled for all blends compared to pure PA-12. The polyimide phase did not have any effect on the degree of crystallinity or the crystal forms of PA-12. For PA-12/PI blends, the decrease in the amorphous lamellae thickness was linked with the increase in Young's modulus and yield strength.

1-26. (canceled)

27. A process to produce a reinforced polyamide characterized in that it comprises:
a) providing components being one or more polyamides, one or more dianhydrides, and one or more diamines; wherein the one or more polyamides are provided at a content ranging from 60 to 97 wt. % based on the total weight of the components and wherein the one or more polyamides comprise at least one polyamide having amide groups separated by at least 10 CH₂ groups;
b) performing in situ synthesis of a polyimide by reactive extrusion of the components in a twin-screw extruder comprising a main hopper wherein the screw profile comprises two or more reverse conveying elements forming two or more hot zones to form a polyamide-polyimide blend wherein the residence time is less than 10 minutes, wherein the residence time is determined according to the method of the description; and
c) recovering a polyamide-polyimide blend being a reinforced polyamide comprising a continuous polyamide phase and a dispersed polyimide phase.

28. The process according to claim 27 is characterized in that the in situ synthesis of a polyimide in the one or more polyamides is performed by adding stoichiometric amounts of dianhydride and diamine.

29. The process according to claim 27 is characterized in that the residence time in step (b) is ranging from 20 seconds to 5 minutes.

30. The process according to claim 27 is characterized in that the polyimide has a glass temperature transition (Tg) of at least 135° C. as determined by DSC according to the description.

31. The process according to claim 30 is characterized in that the polyimide has a glass temperature transition (Tg) ranging from 140 to 200° C. as determined by DSC according to the description.

32. The process according to claim 27 is characterized in that the one or more polyamides comprise at least one polyamide having amide groups separated by 10 to 12 CH₂ groups.

33. The process according to claim 27 is characterized in that the one or more polyamides are selected from polyamide 11, polyamide 12, polyamide 12.12, polyamide 10.10, polyamide 10.12, and polyamide 11.12.

34. The process according to claim 27 is characterized in that the one or more dianhydrides provided at step (a) are selected from pyromellitic dianhydride (PMDA) 3,3′,4,4′-benzophenone tetracarboxylic dianhydride (BTDA), 3,3′,4,4′-biphenyl tetracarboxylic dianhydride (BPDA), 1S,2R,4S,5R-cyclohexanetetracarboxylic dianhydride (H-PMDA), 1,2,3,4-cyclobutanetetracarboxylic dianhydride (CBDA), bicyclo-[2.2.2]oct-7-ene-2-exo,3-exo,5-exo,6-exo-2,3,5,6-dianhydride (BTA), and any mixture thereof.

35. The process according to claim 27 is characterized in that one or more dianhydrides provided in step (a) are aromatic dianhydrides.

36. The process according to claim 35 is characterized in that the one or more dianhydrides provided in step (a) are or comprise pyromellitic dianhydride (PMDA) 3,3′,4,4′-benzophenone tetracarboxylic dianhydride (BTDA), 3,3′,4,4′-biphenyl tetracarboxylic dianhydride (BPDA), and any mixture thereof.

37. The process according to claim 27 characterized in that one or more diamines provided in step (a) are branched aliphatic diamines.

38. The process according to claim 37 is characterized in that one or more diamines are selected from trimethyl hexamethylenediamine (TMD), methyl pentamethylenediamine (MPMD), and methyl octamethylenediamine (MOMD).

39. The process according to claim 38 is characterized in that one or more diamines are trimethyl hexamethylenediamine (TMD).

40. The process according to claim 27 characterized in that the two or more reverse conveying elements are selected from kneading left-handed element and/or left-handed elements; with preference, the two or more hot zones comprise a first hot zone comprises successive kneading blocks elements over a length of at least 4 D followed by a left-handed element with D being the screw diameter, and one or more additional hot zones placed downstream the first hot zone are filled mixing zones, each comprising kneading blocks elements over a length of at least 4 D followed by a kneading left-handed element or by a left-handed element with D being the screw diameter.

41. The process according to claim 27 characterized in that the polyimide in the polyamide-polyimide blend recovered in step (c) is an aliphatic-aromatic polyimide.

42. The process according to claim 27 characterized in that the polyamide-polyimide blend recovered at step c) further comprises one or more copolymers as evidenced by ¹³C NMR spectra.
